(19) United States
(12) Patent Application Publication
(10) Pub. No.: US 2009/0025230 A1
(43) Pub. Date: Jan. 29, 2009

(54) Candle renewer

(76) Inventor: Regis A. Mannke, JR., Pittsburgh, PA (US)

Correspondence Address: JAMES RAY & ASSOCIATES, 2640 PITCAIRN ROAD, MONROEVILLE, PA, 15146, US

(21) Appl. No.: 11/881,065

(22) Filed: Jul. 25, 2007

(51) Int. Cl. B26B 27/00

(52) U.S. Cl. 30/115

(57) ABSTRACT

An apparatus for one of cutting and chopping wax remnants of candles disposed in glass containers, such remnants cling to the sides of the glass container while such candle burns leaving a depression in a center portion of such candle. The apparatus comprises an elongated handle member having a predetermined shape and formed of a predetermined material and a cutting member engageable with a bottom portion of the elongated handle member for cutting and chopping such candle remnants clinging to the sides of such glass container. There is also a central opening disposed in the cutting member for fitting over the wick portion of such candle when such cutting member is used for cutting and chopping such candle remnants so as to not damage the wick.

### FIELD OF THE INVENTION

The present invention relates, in general, to a candle, and, more particularly, the present invention relates to an apparatus for cutting the candle portion remaining on the edge of glass containers and adding it to the existing candle so as to extend the life of the candle.

### BACKGROUND OF THE INVENTION

Candle lovers burn candles quite often. They burn candles to enjoy the fragrance that the candles emit. Generally these candles are relatively large candles that are in glass containers as opposed to the taper candles that are used with candle holders.

The candles and glass holders can come in a variety of sizes and shapes. However, the most common are the pillar candles that come in cylindrical jars or containers. These candles usually are quite wide with a wick in the center. As the candle burns the wax around the wick melts and a pool of wax is seen around the wick. As the candle continues to burn the center portion becomes depressed or, in other words, a cavity is formed in the center and the wax on the sides close to the glass remains at the level it was.

Thus, the candle portion next to the wick is used up while there is still a significant amount of the candle that is untouched. If the candle is allowed to burn to the bottom there is a significant portion of the candle remaining on the sides of the container. Since candles are relatively expensive the unused portion of the candle, which can amount to about a third of the wax, represents a considerable loss.

Thus, it would be advantageous if there were an apparatus or a means for enabling a candle lover to use the wax that clings to the sides of the glass container and thereby get the most value out of a candle.

### SUMMARY OF THE INVENTION

In a first aspect the present invention provides an apparatus for one of cutting and chopping wax remnants of candles disposed in glass containers, such remnants cling to the sides of the glass container while such candle burns leaving a depression in a center portion of such candle. The apparatus comprises an elongated handle member having a predetermined shape and formed of a predetermined material and a cutting means formed of a second preselected material engageable with a bottom portion of the elongated handle member. The cutting means is for cutting and chopping such candle remnants clinging to the sides of such glass container. There is also a central opening disposed in the cutting means for fitting over the wick portion of such candle when such cutting means is used for cutting and chopping such candle remnants so as to not damage the wick.

### OBJECTS OF THE INVENTION

It is, therefore, one of the primary objects of the present invention to provide an apparatus for cutting and chopping wax remnants of candles disposed in glass containers that cling to the sides of the containers.

Another object of the present invention to provide an apparatus that will not damage the wick of the candle.

Still another object of the present invention to provide an apparatus for cutting and chopping wax remnants of candles disposed in glass containers where the apparatus has cutting edges.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of the apparatus for cutting and chopping wax remnants according to an embodiment of the invention.

FIG. 2 is a perspective view of the apparatus for cutting and chopping wax remnants according to an alternate embodiment of the invention.

FIG. 3 is a perspective view of the apparatus for cutting and chopping wax remnants according to yet another embodiment of the invention showing the candle and container.

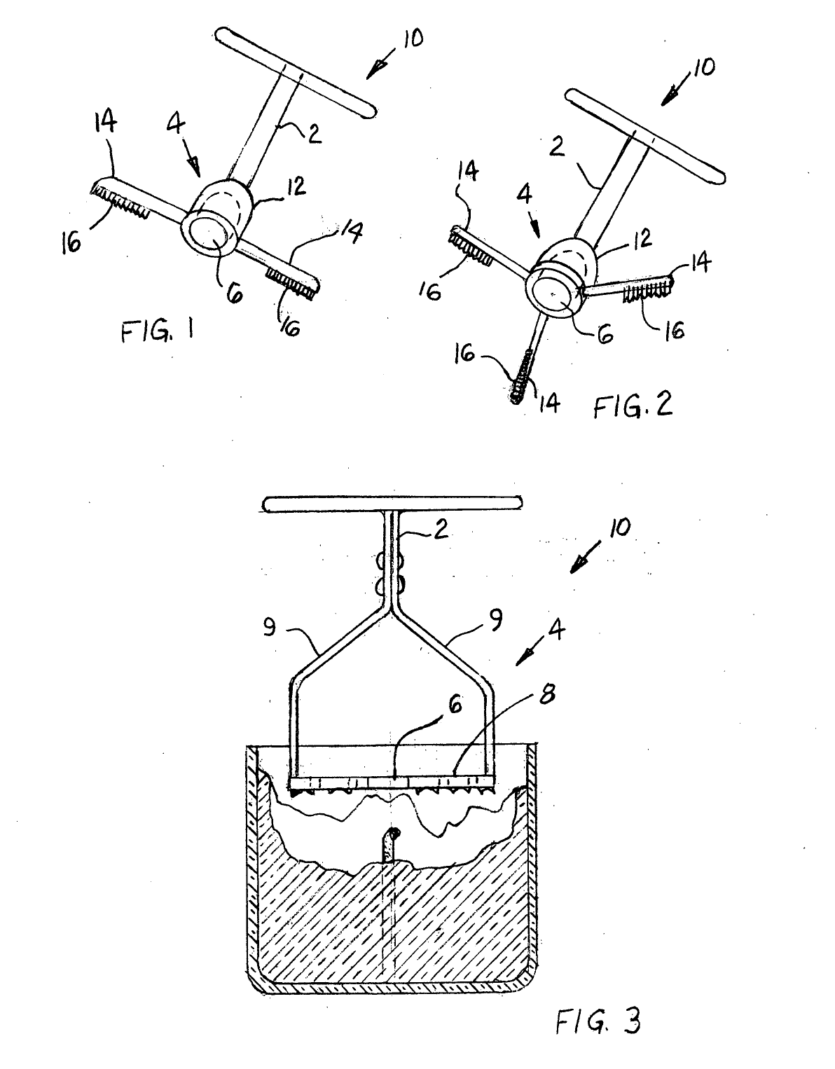

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for one of cutting and chopping wax remnants of candles disposed in glass containers, such remnants cling to the sides of the glass container while such candle burns leaving a depression in a center portion of such candle. The apparatus 10 comprises an elongated handle member 2 having a predetermined shape and formed of a predetermined material and a cutting means 4 formed of a preselected material engageable with a bottom portion of the elongated handle member 4. The cutting means 4 is for cutting and chopping such candle remnants clinging to the sides of such glass container. There is also a central opening 6 disposed in the cutting means 4 for fitting over the wick portion of such candle when such cutting means 4 is used for cutting and chopping such candle remnants so as to not damage the wick.

In a first embodiment of the invention the cutting means 4 includes a circular member 8 disposed on a bottom portion of the elongated handle member 2, such circular member 8 having sharp edges for cutting and chopping such candle remnants. The circular member 8 has a predetermined diameter. The predetermined diameter would be slightly less than the diameter of the glass container holding the candle. Since the containers come in different sizes the predetermined diameter would be that designed for each size of such glass containers.

The cutting means 4 further includes braces 9 that are engageable with the circular member 8 and with the elongated handle member 2 for providing strength to the circular member 8.

In another embodiment the cutting means 4 includes a central portion 12 that is engageable with the elongated handle member 2. The central portion 12 having at least one arm like projection 14 that extends outwardly therefrom. It is presently preferred that such central portion 12 includes a plurality of arm like projections 14, and is also presently preferred that such plurality of projections 14 are three.

The three arm like projections 14 are symmetrically disposed around the central portion 12 of the cutting means 4. Such at least one arm like projection 14 has a cutting edge 16 disposed on an outer edge of the at least one arm like projection 14.

In an alternate embodiment such at least one arm like projection 14 is two. The two arm like projections 14 are radially disposed on the central portion 12 of the cutting means 4.

The cutting edge 16 disposed on an outer edge of the two arm like projections 14 is disposed on opposed edges so that as the apparatus 10 is turned the cutting edges 16 will each contact such candle remnants clinging to such sides of such glass container.

It is presently preferred that such preselected material used for forming such cutting means is selected from a group consisting of metal and plastic and even more preferred that such material is metal and that such metal is steel. It is also preferred that such predetermined material for forming the elongated handle member is also selected from one of metal and plastic and that such material is metal.

Thus, the present invention provides a means for renewing a candle contained in a glass container that has been used and the center portion is depressed while portions of the wax cling to the sides of the glass container. Eventually if left untouched a large portion of the candle will remain on the sides of the container while the center is completely used up. With the use of the present invention the wax clinging to the sides of the glass is chopped or cut up so that the chopped remnants fall into the depressed center portion, thus, extending the useful life of the candle. As the candle burns some of the remnants also melt and are used up in place of or in addition to the remaining portion of the candle. Such use of the present invention is said to extend the life of the candle from between about 25 to 33 percent and since the cost of these glass contained candles is relatively high such savings can be appreciable.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for one of cutting and chopping wax remnants of candles disposed in glass containers, such remnants cling to sides of such glass container while such candle burns leaving a depression in a center on such candle, said apparatus comprising:
(a) an elongated handle member having a predetermined shape and formed of a predetermined material,
(b) a cutting means formed from a preselected material engageable with a bottom portion of said elongated handle member for cutting and chopping such candle remnants clinging to such sides of such glass container; and
(c) a central opening disposed in said cutting means for fitting over a wick portion of such candle when said cutting means is used for cutting and chopping such candle remnants.

2. The apparatus, according to claim 1, wherein said cutting means includes a circular member disposed on a bottom portion of said elongated handle member, said circular member having sharp edges for cutting and chopping such candle remnants.

3. The apparatus, according to claim 2, wherein said circular member has a predetermined diameter.

4. The apparatus, according to claim 2, wherein said cutting means further includes braces engageable with said circular member and said elongated handle member for providing strength to said circular member.

5. The apparatus, according to claim 1, wherein said cutting means includes a central portion engageable with said elongated handle member, said central portion having at least one arm like projection extending outwardly therefrom.

6. The apparatus, according to claim 5, wherein said central portion of said cutting means includes a plurality of arm like projections.

7. The apparatus, according to claim 6, wherein said central portion includes three arm like projections.

8. The apparatus, according to claim 7, wherein said three arm like members are symmetrically disposed around said central portion of said cutting means.

9. The apparatus, according to claim 5, wherein said at least one arm like projection has a cutting edge disposed on an outer edge of said at least one arm like projection.

10. The apparatus, according to claim 9, wherein said central portion includes two arm like projections.

11. The apparatus, according to claim 10, wherein said two arm like projections are radially disposed on said central portion of said cutting means.

12. The apparatus, according to claim 9, wherein each said cutting edge disposed on an outer edge of said two arm like projections is disposed on opposed edges so that as said apparatus is turned said cutting edges will each contact such candle remnants clinging to such sides of such glass container.

13. The apparatus, according to claim 1, wherein said preselected material is selected from a group consisting of metal and plastic.

14. The apparatus, according to claim 13, wherein said preselected material is metal.

15. The apparatus, according to claim 14, wherein said metal is steel.
